(19) United States
(12) Patent Application Publication
(10) Pub. No.: US 2012/0073683 A1
(43) Pub. Date: Mar. 29, 2012

(54) METHOD FOR PRODUCING A MOLDED PART, AND A MOLDED PART THUS PRODUCED

(76) Inventors: Dragan Griebel, Schonwald (DE); Volker Böhm, Sparneck (DE); Alexander Oelschlegel, Konradsreuth (DE); Nobert Honheiser, Selbitz (DE); Karlheinz Winter, Rehau (DE); Andreas Seifert, Rehau (DE)

(21) Appl. No.: 13/376,602

(22) PCT Filed: Jun. 14, 2010
(86) PCT No.: PCT/EP2010/003562

§ 371 Date: Dec. 7, 2011

(30) Foreign Application Priority Data
Jun. 16, 2009 (DE) 10 2009 025 385.8

(51) Int. Cl. F15D 1/00; B29C 70/30; B29C 35/08; B29C 49/00

(52) U.S. Cl. 137/561 R; 264/523; 156/148; 264/459

(57) ABSTRACT

The invention relates to a molded part for accommodating, conducting, or storing a fluid, having a hollow body delimited by a wall lining, and at least one device for feeding fluids to the hollow body, and/or discharging fluids therefrom. The molded part is characterized in that the wall lining contains cross-linked polyethylene.

The invention relates to a method for producing a molded part and to a molded part thus produced for accommodating, conducting or storing a fluid, the molded part having a hollow body delimited by a wall lining, and at least one device for feeding fluids to the hollow body and/or discharging fluids therefrom.

Finally, the invention relates to a fluid supply system comprising at least one such molded part.

Molded parts for accommodating, conducting, or storing gaseous or liquid media having a hollow body with a wall lining are known from the prior art.

Such molded parts are used, for example, in the form of containers for supplying fluids in motor vehicles, wherein said container contains and provides gaseous or liquid and sometimes also combustible substances.

It is further known from the prior art that the wall lining of the molded part consists of a polymer material.

The disadvantage of said known prior art is that during the operation of the molded part in an environment of elevated temperature, for example, in the engine compartment of a motor vehicle, the heat prevailing therein can significantly reduce the strength and dimensional stability of the molded part. This can result in damage to the molded part.

Proceeding from this prior art, it is an object of the invention to provide a method for producing a molded part, and a molded part thus produced which can be operated without being damaged due to the impact of heat.

Finally, it is also an object of the invention to propose a fluid supply system comprising at least one such molded part.

The object is achieved in that the method for producing a molded part comprises the following steps:

The wall lining of the molded part is produced with a blow molding method using polyethylene.

For this purpose, a tube is extruded using a method known per se, wherein said tube is then enclosed by means of a molding tool and molded by blowing in a fluid.

Subsequently, the polyethylene of the wall lining is peroxide cross-linked, or silane cross-linked, or cross-linked under the influence of radiation energy.

Cross-linking can take place immediately after the molding process or only after an extended period of time. The latter can be carried out such that first a number of molded parts is produced which, after temporarily storing them in suitable conditions—even over a period of several weeks, are then cross-linked.

Particularly preferred here is peroxide cross-linking forming so-called PE-Xa, wherein cross-linking the polyethylene takes place under elevated temperature by means of radical-forming peroxides.

When cross-linking polyethylene, chemical compounds between adjacent polymers chains are established so that a highly ductile and particularly temperature-stable polymer material is created which is perfectly suited for the above-described intended use.

The degree of cross-linking of the polyethylene can be controlled through selection and quantity of the peroxide and furthermore through the parameters of the cross-linking process. According to the present invention, the degree of cross-linking of the polyethylene can be 5 to 95%, preferred 15 to 90% and particularly preferred 50 to 85%.

Cross-linking degrees in this range result in the high stability of the wall lining against elevated temperature. “Creeping” of the material as it is known from thermoplastics is therefore prevented.

The polyethylene used as a polymer material for producing the hollow body using the blow molding method is a so-called blow-moldable polyethylene.

For this, an adequate low-viscous polyethylene is selected; the MFI is 0.1 to 2 g/10 min at 190° C., the load is 2.16 kg.

The density of such a blow-moldable polyethylene is 0.93 to 0.965 g/cm³, preferred 0.948 to 0.960 g/cm³.

For blow-molding and subsequent cross-linking, in particular so-called “Philips”-types are preferred for this purpose. Such Phillips types are produced by means of a silicate supported chromium catalyst using a polymerization method.

Besides polyethylene, a polyethylene copolymer can also be used for blow-molding; preferred here is a comonomer of a polyolefin based on a C3 to C8 building block.

In order that the polyethylene can be cross-linked, a cross-linking agent, in the present case organic peroxide, is added to the polyethylene. Organic peroxides are particularly suitable for cross-linking polyethylene.

According to the invention, organic peroxides are used here which have a typical cross-linking temperature of greater than or equal to 170° C.

Particularly preferred are such peroxides which have a cross-linking temperature of greater than or equal to 175° C.

In this manner, a particularly uniform and high-grade cross-linking of the polyethylene is achieved.

Further components may be additionally added to the polyethylene.

These components can comprise, for example, stabilizers such as, e.g., phenolic antioxidants, or processing aids such as, for example, antiblocking agents, or cross-linking enhancers such as, for example, TAC (triallyl cyanurate), or TAIC (triallyl isocyanurate), or trimethylolpropane trimethacrylate, or divinylbenzene, or diallyl terephthalate, or trilallyl trimellitate, or triallyl phosphate in concentrations of 0.2 to 2.0 percent by weight.

For cross-linking, the hollow body produced with the blow molding method using polyethylene is exposed over a certain period to elevated temperature.

This can comprise, for example, a period of 10 min at a temperature of 180° C. to 280° C.

During the cross-linking process, in order to prevent collapsing or a dimensional change of the hollow body produced with the blow-molding method using polyethylene, the hollow body can be pressurized during cross-linking by means of continuous overpressure of the blow air (support air) which presses the hollow body into a mold defining the outer contour.

When cross-linking the polyethylene into PE-Xb which is formed by silane cross-linking, first, the so-called two-stage process is to be considered.

The latter is also called the Sioplas process.

For this, the polyethylene is first grafted with a silane with the aid of peroxides; this grafted polyethylene is then mixed with a catalyst batch and thus can be used for producing the hollow body with the blow-molding method.

Suitable as a component of the catalyst batch is an organotin compound such as, for example, DOTL (dioctyltin laurate); in addition, further additives selected from thermal stabilizers, UV stabilizers, and processing aids can also be contained.

Additional additives in this composition of grafted polyethylene and the catalyst batch can be included.

It is also possible to carry out grafting of the silane onto the polyethylene by using a so-called single-stage method. For this, a mixture of polyethylene, silane, peroxide and the catalyst is fed to an extruder. Silane, peroxide, and the catalyst form a liquid phase which is added to the polyethylene.

First, through a so-called reactive extrusion, grafting the silane onto the polyethylene is performed, wherein a homogenous mixing with the catalyst takes place at the same time.

Cross-linking the polyethylene takes place in the presence of humidity at an elevated temperature; this is usually carried out in a steam atmosphere or in a water bath of 90 to 105° C. over a period of 6 to 15 hours, depending on the wall thickness of the hollow body to be blow molded.

It is also possible to cross-link polyethylene under the influence of radiation energy; this is then referred to as PE-Xc.

For this, substantially all polyethylenes and copolymers thereof are suitable.

Cross-linking of the polyethylene is achieved through the effect of electron beams or gamma beams.

Also, the support of TAC or TIAC can be used during cross-linking.

Finally, it is also possible to cross-link polyethylene by using UV light in that so-called photoinitiators, for example, substituted benzophenones and similar substances, are added to the polyethylene which start the cross-linking reaction under the influence of UV light.

The molded part provided according to the invention for accommodating, conducting, or storing a fluid has a hollow body which is delimited by a wall lining. Said wall lining can have a multi-layered structure. At least one device is provided therein for feeding the fluid to the hollow body and/or discharging the fluid therefrom.

The molded part for accommodating, conducting, or storing the fluid is characterized according to the invention in that the wall lining contains cross-linked polyethylene.

With the inventive selection of cross-linked polyethylene for the wall lining, a molded part is provided which permits it to be operated at elevated ambient temperatures.

In particular, no thermal deformation of the molded part occurs; the material of the wall lining cannot “flow away” under the influence of heat.

The molded part according to the invention can be operated at a permanent operating temperature of 150° C.

According to the invention, a refinement of the molded part can comprise, in addition to the wall lining made of cross-linked polyethylene, an outer layer arranged on said wall lining. The outer layer on the wall lining contains a filament or a thread which consists, for example, of carbon, or of aramid, or of metal, or of boron, or of glass, or of a silicate material, or of aluminum oxide, or of a highly ductile and highly temperature-resistant polymer material, or of a mixture of the aforementioned materials. The latter are also called hybrid yarns.

This fiber reinforcement of the outer layer on the wall lining further contains a polymer material, preferably an epoxy resin.

Said filaments or threads which are contained in the outer layer on the wall lining are wrapped and/or braided.

The wrapping can in particular be provided in such a manner that it is formed stronger at certain selected places of the molded part so as achieve there a particularly high stability.

Also, it can advantageously be provided that the wrapping is formed so as to be particularly strong in the region of the device for feeding and/or discharging the fluid or at other places in order to strengthen the molded part at this place.

Likewise, it can be advantageous if at selected places of the molded part, and/or in the region of the device for feeding and/or discharging the fluid, or at other places, a specific braiding technique is used which differs from the braiding technique that is used at other places of the molded part. Such a specific braiding technique can give the outer layer on the wall lining a particular high strength.

According to the invention it can be provided that the outer layer is not connected to the wall lining. This can offer advantages in terms of long-term stability of the molded part.

In another embodiment of the invention, it is also possible that the wall lining is connected to the outer layer. Hereby, a particularly durable molded part can be created.

Furthermore, the molded part has at least one device for feeding the fluid to the hollow body and/or discharging the fluid therefrom. This so-called “boss” is an opening in the wall lining of the molded part which serves for filling the molded part with the fluid to be accommodated or for emptying it.

It can advantageously be provided that at a location of the surface of the molded part, located approximately opposite to said “boss”, a means is provided that facilitates applying the outer layer by wrapping and/or braiding. Said means can be a projection of the surface or can comprise an indentation provided therein in which, for example, an axle can be introduced, or a similar configuration.

With the aid of said means, the molded part is then easier to handle for the wrapping or braiding operation. For example, said means can serve for centering the molded part during the wrapping and/or braiding operation. Also, it can advantageously be used as a wrapping fixture in order to move the molded part. Finally, said means can also be used for fixing the molded part during the subsequent use.

Thus, this results in a better quality of the outer layer to be applied. The molded part can therefore be produced to be more durable.

In a refinement of the present invention, it can be provided that the molded part has an outer protective layer which is applied onto the wall lining.

The outer protective layer can contain a thermoplastic, or a coextrudate, or a shrink tubing, or a knitted fabric, or an interlaced fabric, or a meshwork, or a combination thereof.

Such an outer protective layer of the molded part is advantageous if the latter is exposed to mechanical load such as, for example, impacts or similar forces acting thereupon.

Such an outer protective layer prevents in particular damage, for example to the outer wall lining that can occur which could result in breaking said wall lining.

The outer protective layer can also be configured such that it forms a fire protection layer which protects the molded part effectively against the influence of fire. For this, it can advantageously be provided that the fire protection layer contains so-called intumescent materials which, under the influence of elevated temperature, release gases or water and thus cool the molded part and/or shield it against the influence of hot gases, and/or by forming a heat-insulating layer with low heat conductivity, protecting the molded part for a certain time against the influence of heat.

Such intumescent materials are, for example:

Compositions, the compositions comprising a “carbon” donor (e.g. polyalcohols), an acid donor (e.g. ammonium polyphosphate), and a propellant (e.g. melamine). The latter then form a voluminous, insulating protective layer by carbonization and simultaneous foaming.

Other intumescent materials comprise, for example, hydrates which, under the influence of heat, develop an endothermic effect by releasing cooling vapor. An example for this is hydrated alkali metal silicate.

Also known are gas-releasing intumescent materials which comprise, for example, melamine, methylolated melamine, hexamethoxymethylmelamine, melamine monophosphate, melamine biphosphate, melamine polyphosphate, melamine pyrophosphate, urea, dimethylurea, dicyandiamide, guanyl urea phosphate, glycine, or amine phosphate.

The aforementioned materials release gaseous nitrogen when they decompose under the influence of heat. Compounds which release carbon dioxide or water vapor under the influence of heat could also be used.

The outer protective layer can also serve for identifying the molded part by recording or imaging information which is applied in alphanumeric form, or as a barcode, or as a color code.

Finally, the outer protective layer can also be provided for giving the molded part an attractive appearance.

Also, in one refinement of the invention, a metal layer can be provided.

Said metal layer can be arranged on the inner layer. The metal layer is preferably configured such that it does not resist the diffusion of the fluid through the wall lining of the molded part.

For this purpose, the metal layer can be perforated, for example, or is arranged only in certain sections.

In this way, it is possible to produce a particularly robust molded part.

In another embodiment, the metal layer can also be provided on the reinforcement layer.

Thereby, a molded part having a particularly strong wall lining is obtained.

Finally, the metal layer can also be arranged on the outer layer of the molded part.

In this case, the molded part is specifically protected against external influences such as impacts or forces acting thereupon.

In one refinement of the invention it can be provided that the molded part has fastening means which are fastened on the outer wall lining. Said means can comprise brackets or strips made of metal or polymer material. In particular, the molded part can have fastening means which are formed on the layer arranged on the outside of the wall lining. Also, it can advantageously be provided that fastening means are formed on the outer protective layer.

In this way, the molded part can be fastened in an advantageous manner, for example, in an installation situation in a vehicle.

In one refinement of the invention, it can be provided that the molded part has a sensor element in or on at least one layer of the wall lining. Said sensor element, for example, can be a strain gage which, in case of a length change, outputs information via a signal connection.

Thus, in the event of damage, for example, if the molded part is overstretched or mechanically damaged due to a malfunction or an operating error, a display can be triggered which disables a continued operation of the molded part and thus averts dangers.

Also, in one refinement of the invention, the molded part can include an identification element which clearly characterizes the molded part and provides data.

This can comprise data on the molded part's history of origins (life cycle during production and use), on its operation, or on other conditions.

Said identification element can be, for example, a barcode, an alphanumeric code, an embossed or recessed element, a hologram, a color element, or an RFID element (Radio Frequency Identification Device, identification by means of electromagnetic waves), or a similar element.

Thus, it is possible to enable and/or ensure quality assurance for the molded part as well as tracking of its operation.

A fluid supply system according to the invention comprising at least one molded part of the above-described type is preferably used for a motor vehicle in the form of a container, or a holding element, or an air conveying part, or in a stationary or mobile, in particular, decentralized energy generating device.

The present invention is explained in more detail with reference to the figures.

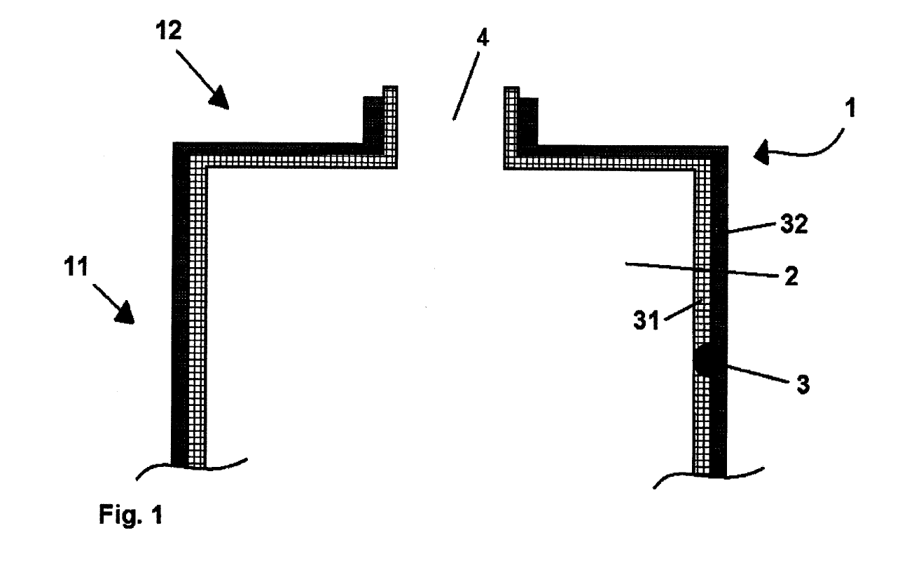

FIG. 1 shows a schematic sectional illustration of a section of a molded part according to the invention;

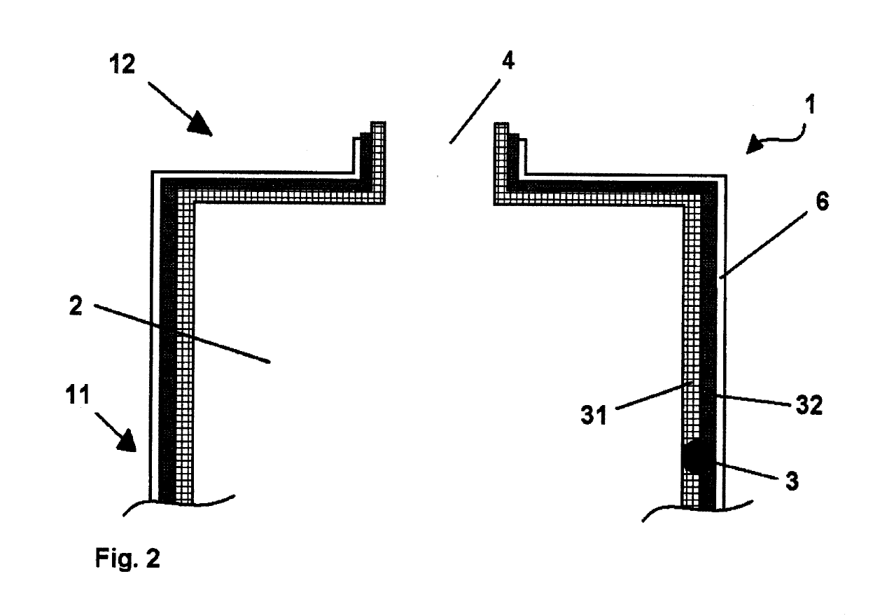

FIG. 2 shows a schematic sectional illustration of a section of a second molded part according to the invention.

FIG. 1 schematically shows a section of a molded part according to the invention in the form of a container in a sectional illustration.

Said container 1 has substantially an elongated structure in the form of a cylindrical middle section 11 which has terminal caps 12 (only one is shown in the Fig.) molded thereon on both cylinder ends.

On a terminal cap 12, the device 4 for feeding and/or discharging the fluid is formed.

The hollow body 2 of the container 1 is enclosed by a wall lining 3 having a layer 31 containing cross-linked polyethylene.

The layer 31 is produced in one piece by means of a blow-molding method using polyethylene and is subsequently cross-linked.

Said layer 31 has substantially the same wall thickness everywhere.

The wall lining's 3 layer 32 attached on the outside is a reinforcement layer.

This reinforcement layer is generated by wrapping and/or braiding of threads or fibers; said layer is reinforced by a thermoset material, in the present case by an epoxy resin. Depending on the requirements for the stability at different sections, the layer 32 has different thicknesses. The Fig. shows that the layer 32 is thickened in the region of the device 4 for feeding and/or discharging the fluid because there, forces occur which are to be absorbed by the layer 32. The layer 32 is not connected to the layer 31.

FIG. 2 schematically shows a section of the second molded part according to the invention in the form of a container in a sectional illustration.

On a terminal cap 12, a device 4 for feeding and/or discharging the fluid is formed. On the layer 32, a protective layer 6 is arranged which is configured in the form of a shrink tubing which largely encloses the container.

### Exemplary Embodiment

A blow-moldable polyethylene having a MFI of 0.3 g/10 min at 190° C. with an applied load of 2.16 kg is processed using the blow-molding method to form a molded part in the form of a container. The density of the blow-moldable polyethylene is 0.95 g/cm³.

The blow-moldable polyethylene contains an organic peroxide which has a cross-linking temperature of 175° C.

After the forming operation, the blow-molded hollow body is exposed to a temperature of 240° C. over a period of 5 min for the purpose of cross-linking. For this, the hollow body is protected by support air in the mold against potential dimensional changes.

After the hollow body is cooled down, said hollow body is wrapped with carbon fibers soaked in epoxy resin until a layer thickness of 15 to 45 mm is reached.

The container is permanently durable at a temperature maintained indefinitely at 150° C.

### REFERENCE LIST

1 Container
11 Middle section
12 Terminal cap
2 Hollow body
3 Wall lining
31 Layer
32 Layer
4 Device for feeding and/or discharging the fluid
6 Protective layer

1. A method for producing a molded part for accommodating, conducting, or storing a fluid, the molded part having a hollow body delimited by a wall lining, and at least one device for feeding the fluid to the hollow body, and/or discharging fluids therefrom, wherein the hollow body is produced with a blow-molding method using polyethylene and the polyethylene is cross-linked.

2. The method according to claim 1, wherein the polyethylene is cross-linked using a cross-linking method selected from a group of cross-linking methods consisting of peroxide cross-linking, silane cross-linking, and cross-linking under the influence of radiation energy.

3. The method according to claim 1 wherein the degree of cross-linking of the polyethylene is selected to be 5 to 95%.

4. The method according to claim 1, wherein an outer layer is formed as a reinforcement layer on the wall lining.

5. The method according to claim 4, wherein, for the reinforcement layer, a filament or a thread made of a material selected from a group of materials consisting of carbon, aramid, metal, boron, glass, a silicate material, of aluminum oxide, a highly ductile and highly temperature-resistant polymer material, and a mixture of the aforementioned.

6. The method according to claim 4, wherein the reinforcement layer made of the filament or the thread is wrapped and/or braided.

7. The method according to claim 4 wherein a polymer material, preferably an epoxy resin, is used for the outer layer.

8. The method according to claim 1 wherein an outer protective layer is applied onto the outer layer of the wall lining.

9. The method according to claim 8, wherein as an outer protective layer, a thermoplastic, or a coextrudate, or a shrink tubing, or a knitted fabric, or an interlaced fabric, or a meshwork, or a combination of the aforementioned materials is provided.

10. A molded part for accommodating, conducting or storing a fluid, the molded part having a hollow body delimited by a wall lining, and at least one device for feeding the fluid to the hollow body, and/or discharging the fluid therefrom, produced according to claim 1 wherein the wall lining, which contains cross-linked polyethylene, is produced using the blow-molding method and is cross-linked after the forming operation.

11. The molded part according to claim 10, wherein an outer layer is formed as a reinforcement layer on the wall lining.

12. A fluid supply system comprising at least one molded part according to claim 10, preferably for use in a motor vehicle, or a stationary or mobile, in particular, decentralized energy generating device.

13. The reservoir according to claim 1 wherein the degree of cross-linking of the polyethylene is 15 to 90%.

14. The reservoir according to claim 1 wherein the degree of cross-linking of the polyethylene is 50 to 85%.

15. The reservoir according to claim 2 wherein the degree of cross-linking of the polyethylene is 15 to 90%.

16. The reservoir according to claim 2 wherein the degree of cross-linking of the polyethylene is 50 to 85%.

17. The reservoir according to claim 2, wherein an outer layer of the wall is formed as a reinforcement layer.

18. The reservoir according to claim 3, wherein an outer layer of the wall is formed as a reinforcement layer.

19. The method according to claim 5, wherein the reinforcement layer made of the filament or the thread is wrapped and/or braided.

20. The method according to claim 5, wherein a polymer material, preferably an epoxy resin, is used for the outer layer.
